(19) United States
(12) Patent Application Publication
(10) Pub. No.: US 2010/0312808 A1
(43) Pub. Date: Dec. 9, 2010

(54) METHOD AND APPARATUS FOR ORGANIZING MEDIA DATA IN A DATABASE

(75) Inventor: Dharmesh Mehta, Sunnyvale, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/863,191

(22) PCT Filed: Jan. 25, 2009
(86) PCT No.: PCT/IB2009/050289

§ 371 Date: Jul. 16, 2010

(30) Foreign Application Priority Data
Jan. 25, 2008 (US) 61062326
Jan. 25, 2009 (IB) PCT/IB2009/050289

(51) Int. Cl. G06F 17/30

(52) U.S. Cl. 707/825; 707/E17.143

(57) ABSTRACT

A method and an apparatus for organizing media files in a database. Embodiments of the present invention provides a method to associate artwork to a media file. A plurality of first data artwork images is provided. A plurality of second data is generated based on the first data, each second data identifiers for the artwork images corresponding to a different first data of the plurality of first data. A plurality of third data media files is provided and each third data has at least one attribute and a reference field for storing a corresponding second data. Each third data is identified in the database by the at least one attribute and the reference field. And, a plurality of fourth data album titles each associated with a subset of the plurality of third data is provided.

The present invention relates to a method and apparatus for organizing a data resource in a database, and in particular, organizing media files in a database. As the methods for storing and accessing audio/visual media (e.g., video, music) have progressed to the digital domain, the method and system for storing, organizing, and accessing the stored audio/visual media have also evolved. A common method of storing audio/visual media is by way of encoding and storing the media as digital files. Each digital file has a filename that allows the file to be stored, organized and searched in various digital storage systems.

Due to the increasing capacity of modern storage systems, a vast number of audio/visual files can be stored in a single system. For example, one gigabyte of data storage space can easily store 200 or more high quality audio files. A simple digital portable audio player can contain over a thousand song titles. When the number of song titles is relatively small, it is relatively simple and feasible to organize audio files by using different file names. The audio files can be generated from a number of different sources such as copying from a compact disc (CD) album, downloading from the Internet, or purchasing from an online music download site. In the case of music/song titles, most of the commercially available music/song titles are released both online and on CD album. Notwithstanding the original sources, it is desirable to associate a music/song title with a corresponding image (e.g., an album artwork) to facilitate navigation of the music/song titles in a storage system (e.g., database) which can contain a large number of music/song titles because humans generally perceive visual information easier and faster than textual information. It is also desirable to provide a visual image to enhance the user's experience. Still, it is desirable to associate the same image to more than one music/song title in a storage system to reduce the storage requirement to store multiple copies of the same image.

Embodiments of the present invention provide a method of organizing data in a database. Embodiments of the present invention also provide an apparatus for organizing data in a database system.

In one embodiment, a method of organizing data in a database is provided. A plurality of first data is provided. A plurality of second data is generated based on the first data, each second data corresponds to a different first data of the plurality of first data. A plurality of third data is provided, and each third data has at least one attribute and a reference field for storing a corresponding second data of the plurality of second data. Each third data is identified in the database by the at least one attribute and the reference field. A plurality of fourth data is provided, and each is associated with a subset of the plurality of third data. A query of a fourth data of the plurality of fourth data generates an output. The output includes a corresponding subset of the plurality of third data. A corresponding subset of the plurality of first data associated with the subset of the plurality of third data is identified by using the second data stored in reference fields of the subset of the plurality of third data.

Furthermore, the plurality of first data can include album artworks. The plurality of first data can include digital images. The digital images can include one or more of JPEG images, bitmap images, GIF images, TIFF images. The plurality of second data can include hash codes of the digital images. The plurality of third data can include audio files. The plurality of fourth data can include album titles, each of the album titles corresponding to one or more of the audio files. The at least one attribute can include the title of a corresponding one of the audio files. The at least one attribute can further include at least one of artist name, album title, genre, track number, title, or date.

In another embodiment according to the present invention, an apparatus for organizing data in a database system is provided. A first data storage unit is provided for storing a plurality of first data. A second data storage unit is provided for storing a plurality of second data, and each second data corresponds to a different first data of the plurality of first data. A computing unit is provided for generating the second data based on the first data. A third data storage unit is provided for storing a plurality of third data, and each third data has at least one attribute and a reference field for storing a corresponding second data of the plurality of second data. Each third data is identified in the database by the at least one attribute and the reference field. A fourth data storage unit is provided for storing a plurality of fourth data, and each fourth data is associated with a subset of the plurality of third data. A communication channel is provided between the first, second, third and fourth data storage units and the computing unit. A query of a fourth data of the plurality of fourth data generates an output including a corresponding subset of the plurality of third data. A corresponding subset of the plurality of first data associated with the subset of the plurality of third data is identified by using the second data stored in reference fields of the subset of the plurality of third data.

Furthermore, the plurality of first data can include album artworks. The plurality of first data can include digital images. The digital images can include one or more of JPEG images, bitmap images, GIF images, or TIFF images. The plurality of second data can include hash codes of the digital images. The plurality of third data can include audio files. The plurality of fourth data can include album titles, and each of the album titles corresponds to one or more of the audio files. The at least one attribute can include the title of a corresponding audio file. The at least one attribute can further include at least one of the followings: artist name, album title, genre, track number, title, or date. The first, second, third and fourth data storage units can be included in a storage unit.

The accompanying drawings, together with the specification, illustrate exemplary embodiments of the present invention, and, together with the description, serve to explain the principles of the present invention.

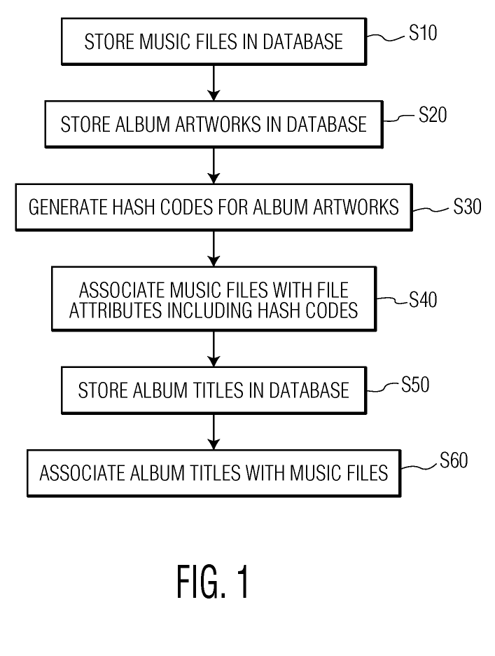

FIG. 1 is a flowchart of an exemplary method of organizing media files in a database in accordance with an embodiment of the present invention.

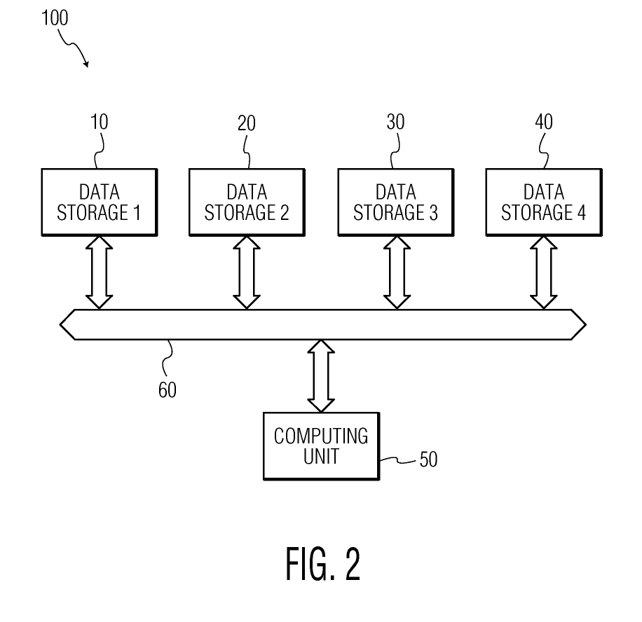

FIG. 2 is an apparatus for organizing media files in a database in accordance with another embodiment of the present invention.

Detailed descriptions will be made below in reference to certain exemplary embodiments according to the present invention. The drawings and descriptions are to be regarded as illustrative in nature and not restrictive.

In a storage system (e.g., database) containing a collection of media files (e.g., music titles, video titles), it is desirable to associate a visual artwork with each of the media files provide a visual representation of the media file to a user. In the case of music titles, an album artwork can be associated with one or more music titles to provide a visual representation of the music titles. When a database query is made on a music title, the album name and the album artwork associated with that music title are output or displayed by the database to a user. Music titles and album names are stored in the database in the form of text strings. In the event that multiple music titles share the same album name text string, multiple music titles with identical text strings should be output by the database query, each with their respective associated album artwork displayed. In addition, the database can offer the option to search music titles based on album artworks and navigate through content based on album artworks. It should be appreciated by a person skilled in the art that the same principle can be applied to video titles or other file types stored in a storage system.

Each music title stored in the database is associated with a number of attributes such as, but not limited to, the artist name, album name, genre description and album artwork. For most music albums, there is a one-to-one correlation between the music title and the respective attributes; however, compilation albums can cause this algorithm to fail. For example, a compilation album can contain music titles from various artists each can be classified to a different genre. A conventional method creates association between a music title and its attributes based on unique artist/album grouping. In this conventional method, the first music title in an artist/album group is assumed to be the album artwork for all titles in that group. However, this algorithm fails with multi-genre compilation music albums. Another problem with the conventional method occurs when the artist or album text strings are edited by a user. When the original artist or album text strings are edited, multiple instances of the same album artworks can be shown; or music titles may ‘inherit’ the new album text string for album navigation as the corresponding music titles are moved from one container to another (i.e., based on album or artist text sting edits). In conventional art, every music title can be associated to a unique album artwork by creating a association between the music title text string and the artwork in the database. As such, the title string should be fixed.

Embodiments of the present invention provide a solution to extend the uniqueness of the music title. In addition to the artist name, album name and other general attributes (e.g., genre, track number, track title, date, etc.,) additional information unique to the navigable resource is added. In one embodiment, the hash code of the a digital image (e.g., JPEG, GIF, TIFF and bitmap) of an album artwork is used to further extend the uniqueness of the music title. Once a hash code (e.g., hash-key) is derived and associated with the music title, it becomes the unique key for identifying the album artwork associated with the music title. In other words, the correct album artwork for a music title is referenced in the database by the hash code of the corresponding album artwork. As long as the hash code associated with a music title remains unchanged, the correct album artwork can be retrieved from the database by using the hash code as an index to indicate the correct album artwork to be retrieved. Similar extension can be made to album names stored in the database. Each album name has an attribute associated with an album artwork hash code. Therefore, changing of the album name will not affect the association of an album artwork as long as the attribute containing the hash code is not changed.

On an album query, an album name text string is input to the database. The database query engine checks the number of unique hash codes in the database and determine, therefore, how many album artworks should be output for the album query. In addition, the query result can be a list of albums with names matching the search string. Also, the album list showing the corresponding album artworks can be sorted; therefore, alphanumeric search on the album list remains possible on the artwork view. In another words, album level uniqueness is dependent on the album name and the image hash code; therefore, other albums cannot be associated with the wrong image following edit operations of the album name text string.

Embodiments of the present invention can be applied to an audio media file server system, in which each media file (i.e., music tracks) can be viewed as one or more by per artist, album, genre or all-tracks container. When media files are added into the database, they are inserted with corresponding hash codes of album artworks. If a hash code is not available at that time for a particular media file, a unique default code be generated automatically by the system and updated by the database later if an album artwork is available. In a database implemented according to the embodiments of the present invention, even if different music titles have the same associated album name, which occurs frequently in a database containing a large number of music titles, each music title's album artwork is uniquely identified by the hash code generated from the corresponding artwork.

In another application, a music title database according to embodiments of the present invention can be used in set-top-box (STB) applications. The server application is ported to STBs so that a user can purchase content from the web/Internet and browse the content on his television screen. Graphical navigation is generally more powerful on the STB platform and can be a key differentiator among competing content service providers when the STB implementing embodiments of the present invention provides correctly linked images for easy navigation through the available content.

FIG. 1 illustrates one embodiment according to the present invention, the embodiment providing an exemplary method of organizing music titles in a database. In step S10, a collection of music files is provided and stored in a database, and is available for access. In step S20, a collection of album artworks corresponding to the collection of music files is provided and stored in the database. As a non-limiting example, the album artworks are JPEG images in this embodiment. It should be appreciated that other digital image file formats can be applied. In step S30, unique codes corresponding to each of the album artworks are generated. In this exemplary embodiment, the codes are hash codes generated from the artwork JPEG images. In step S40, each of the music files is identified with a plurality of file attributes. The file attributes include, for example, file identifier, artist name, album name, genre, track number, release date, and album artwork hash code. Using the hash code of an album artwork as an attribute, a music file can be uniquely associated with an album artwork. Therefore, even when the file identifier of the music file is changed, the correct album artwork can be located by using the hash code associated with the music file as an index to identify the correct album artwork. In step S50, a collection of album titles are provided and stored in the database. Each of the album titles has a corresponding album artwork provided in step S20. In step S60, each album title is associated with a compilation of music files which is a subset of the music files stored in the database in step S10. It should be appreciated by a person skilled in the art that the method sequence shown in FIG. 1 can be rearranged to suit a particular implementation, and, as such, the present invention is not limited by the embodiment in FIG. 1. Also, some steps can be executed simultaneously and/or concurrently.

When a query is made on the music files, music files matching the query condition are displayed with the correct corresponding album artworks by using the hash codes stored as an attribute of the music files to index the correct album artworks. The album artwork is always correctly identified by the hash code associated with a particular music file. Accordingly, the embodiment hereby provides a method of organizing music files in a database, wherein each music file has a uniquely defined album artwork allowing a user to visually search the database by using an album artwork view. Furthermore, the association between the music files and the album artworks is not affected by changes of the identifiers of the music files or the album title. It should be appreciated by a person skilled in the art that this exemplary embodiment can be applied to organizing other files having other media file types (e.g., video files) stored in a database.

In another embodiment according to the present invention, an apparatus 100 for organizing media files in a database system is provided. The apparatus 100 includes a first data storage unit 10, a second data storage unit 20, a third data storage unit 30, a fourth data storage unit 40, and a computing unit 50. The data storage units 10, 20, 30, and 40 and the computing unit 50 communicate through a communication channel 60. The data storage units 10, 20, 30 and 40 can be implemented by, for example, but not limited to, solid state memory, hard drive, flash drive, flash memory, or any device configured to provide data storage and access. In some embodiments, the data storage units 10, 20, 30 and 40 can be a single storage unit. The computing unit 50 can be, for example, but not limited to, a single computer, multiple computers, or a processing unit of a computing system. The communication channel 60 can be any suitable communication medium known in the art to allow data communication between two or more units. Some non-limiting examples are parallel data bus, serial data bus, optical data link, wireless data link, etc., or any combination thereof.

For illustration purposes, music files and JPEG type album artworks are used as exemplary media files to explain the embodiment; however, it should be appreciated that other media file types (e.g., video file) can be applied to the embodiment. A plurality of JPEG type album artworks is stored in the first data storage unit 10. The computing unit 50 generates a plurality of hash codes using the plurality of album artworks and stores the hash codes in the second data storage unit 20. Each hash code corresponds to one of the JPEG type album artworks. In general, different JPEG images generate different hash codes. A plurality of music files are stored in the third data storage unit 30. Each of the music files has a plurality of file attributes. The file attributes includes one or more of, for example, but not limited to, file identifier, artist name, album name, genre, track number, release date, and album artwork hash code. The hash code of an album artwork uniquely relates the album artwork image to the music file. Therefore, even when other attributes (e.g., file identifier) of a music file are changed, the correct album artwork associated with the music file can still be referenced in the database. A plurality of album titles is stored in the fourth data storage unit 40. Each album title is associated with a compilation of a subset of the music files stored in the third data storage unit 30. These album titles can be viewed as analogous to a CD album that contains a number of music tracks. Each album title provides a method to group various music files together in a group. Thus, the music files can be searched by album titles in the database.

The computing unit 50 provides a mechanism to a user to query the database. For example, when a query of an album title is made, a list of music files associated with the album title is produced. Since some users may prefer navigating the database by visual information rather than textual information, it is desirable to display the corresponding album artworks associated with the list of music files produced. According to the embodiment, the correct album artworks can be identified by using the hash codes associated with the music files as index to identify the correct album artworks. Therefore, this embodiment provides an apparatus to search a database of music files (or other media files), wherein each music file is associated with a uniquely defined album artwork allowing a user to visually search the database by using the album artworks. Furthermore, the association between the music files and the album artworks are not affected by changes of other attributes of the music files (e.g., album title) as long as the hash code attributes of the music files are not modified.

While the present invention has been described in connection with certain exemplary embodiments, it is to be appreciated by a person skilled in the art that the invention is not limited to the disclosed embodiments, but, on the contrary, is intended to cover various modifications and equivalent arrangements included within the spirit and scope of the appended claims, and equivalents thereof

What is claimed is:

1. A method of organizing data in a database, the method comprising:
providing a plurality of first data;
generating a plurality of second data based on the plurality of first data, each of the plurality of second data corresponding to a different first data of the plurality of first data;
providing a plurality of third data each having at least one attribute and a reference field for storing a corresponding second data of the plurality of second data, each of the plurality of third data being identified in the database by the at least one attribute and the reference field; and
providing a plurality of fourth data each associated with a subset of the plurality of third data,
wherein a query of a fourth data of the plurality of fourth data generates an output comprising a corresponding subset of the plurality of third data, and
wherein a corresponding subset of the plurality of first data associated with the subset of the plurality of third data is identified by using the second data stored in reference fields of the subset of the plurality of third data.

2. The method of claim 1, wherein the plurality of first data comprises album artworks.

3. The method of claim 1, wherein the plurality of first data comprise digital images.

4. The method of claim 1, wherein the digital images comprise one or more of JPEG images, bitmap images, GIF images, TIFF images.

5. The method of claim 3, wherein the plurality of second data comprise hash codes of the digital images.

6. The method of claim 1, wherein the plurality of third data comprise audio files.

7. The method of claim 6, wherein the plurality of fourth data comprise album titles, each of the album titles corresponds to one or more of the audio files.

8. The method of claim 6, wherein the at least one attribute comprises the title of a corresponding one of the audio files.

9. The method of claim 8, wherein the at least one attribute further comprises at least one of artist name, album title, genre, track number, title, or date.

10. An apparatus for organizing data in a database system, comprising:
a first data storage unit for storing a plurality of first data;
a second data storage unit for storing a plurality of second data, each of the plurality of second data corresponding to a different first data of the plurality of first data;
a computing unit for generating the plurality of second data based on the plurality of first data;
a third data storage unit for storing a plurality of third data, each of the plurality of third data having at least one attribute and a reference field for storing a corresponding second data of the plurality of second data, each of the plurality of third data being identified in the database by the at least one attribute and the reference field;
a fourth data storage unit for storing a plurality of fourth data, each fourth data being associated with a subset of the plurality of third data; and
a communication channel between the first, second, third and fourth data storage units and the computing unit,
wherein a query of a fourth data of the plurality of fourth data generates an output comprising a corresponding subset of the plurality of third data, and
wherein a corresponding subset of the plurality of first data associated with the subset of the plurality of third data is identified by using the second data stored in reference fields of the subset of the plurality of third data.

11. The apparatus of claim 10, wherein the plurality of first data comprise album artworks.

12. The apparatus of claim 10, wherein the plurality of first data comprise digital images.

13. The apparatus of claim 12, wherein the digital images comprise one or more of JPEG images, bitmap images, GIF images, TIFF images.

14. The apparatus of claim 12, wherein the plurality of second data comprise hash codes of the digital images.

15. The apparatus of claim 10, wherein the plurality of third data comprise audio files.

16. The apparatus of claim 15, wherein the plurality of fourth data comprise album titles, each of the album titles corresponds to one or more of the audio files.

17. The apparatus of claim 15, wherein the at least one attribute comprises the title of a corresponding one of the audio files.

18. The apparatus of claim 17, wherein the at least one attribute further comprises at least one of artist name, album title, genre, track number, title, or date.

19. The apparatus of claim 10, wherein the first, second, third and fourth data storage units are included in a storage unit.
